(19) United States
(12) Patent Application Publication
(10) Pub. No.: US 2004/0199921 A1
(43) Pub. Date: Oct. 7, 2004

(54) Import of contact data from personal information manager software into application

(75) Inventors: David Carroll Snader, Eldersburg, MD (US); Stuart Robertson Keyes III, Timonium, MD (US); Kurt Lawrence Stadele, Alpharetta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 10/607,907

(22) Filed: Jun. 27, 2003

Related U.S. Application Data
(60) Provisional application No. 60/451,027, filed on Feb. 28, 2003.

(51) Int. Cl. G06F 3/00

(52) U.S. Cl. 719/310

(57) ABSTRACT

The disclosed methods, apparatus, system, and computer-readable media can be used to map contact data from personal information manager (PIM) software to one or more corresponding fields of an application to automatically populate such application with contact data. The contact data can comprise a person's name, company name, address, telephone number, mobile number, facsimile number, and/or email address. The user of a computer device can input one or more characters into a field of an application, and matching sets of contact data are displayed for the user to select to populate mapped fields of the application.

### CROSS-REFERENCE TO RELATED APPLICATIONS

This patent application is a U.S. nonprovisional application filed pursuant to Title 35, United States Code §§100 et seq. and 37 C.F.R. Section 1.53(b) claiming priority under Title 35, United States Code § 119(e) to U.S. provisional application No. 60/451,027 filed Feb. 28, 2003 naming as inventors David Carroll Snader, Stuart Robertson Keyes, III, and Kurt Lawrence Stadele as inventors. Both the subject application and its provisional application have been assigned, or are under obligation to be assigned, to the same entity.

### BACKGROUND OF THE INVENTION

1. Field of the Invention

This invention relates to web applications available to users via the Internet, World Wide Web, or other communication network, in which the users enter data into browsers of computing devices in the use of such applications. The invention is also directed to use of personal information manager (PIM) software that can be used to store contact data such as a person or company name, mailing address, telephone number, mobile number, facsimile number, email address, etc.

2. Description of the Related Art

A wide variety of web applications currently exist on the Internet or World Wide Web (WWW). Many of these applications are hosted by websites that permit users of browser-based computing devices to access and use such applications via the Internet or World Wide Web (WWW). For example, web applications can permit users to participate in commercial transactions involving sale or purchase of products and services online. Amazon.com and eBay.com are popular examples of websites that execute web applications to permit users to buy, sell, or auction products and services. As another example, the websites www.upscampship.com and www.ups.com enable users to ship letters and packages via web applications. These are but a few examples of the numerous kinds of web applications that exist on the Internet.

In many of these web applications, users must input data such as the name, address, telephone number, mobile number, facsimile number, email address, etc. with each use of the application. This operation of repeatedly having to enter the same data into web applications is a source of great inconvenience to users, and impairs the ability of online merchants to conduct their business. Accordingly, there is a significant need for a technology that will enable a user to automatically populate the field(s) of a web page or form without having to reenter the same data each time a person uses an online application. Moreover, greater benefits could be achieved if a user could enter only one to several key strokes to automatically populate data in the field(s) of a web page without the need to enter all data required by the field(s) of a web page.

Heretofore unrelated to the above discussion, there are a variety of software packages on the market that enable a person to store contact data. This software is generally referred to as Personal Information Manager (PIM) software. Examples of such software include Microsoft® Outlook®, Microsoft® Exchange®, and Symantec® Act!® products, among numerous other messaging and collaboration software packages. Such software allows users to store virtual or electronic cards with contact information for persons with whom the user of such software interacts in personal and business contexts, for example. For many persons, PIM software is the primary source of contact data used for communicating with other persons via telephone, mobile telephone, email, pager, etc. Also, this contact data is often used to send letters and packages, and for many other purposes. For many people, PIM software contains the most complete and up-to-date contact data that such persons use in their personal and professional endeavors.

### SUMMARY OF THE INVENTION

The invention, in its various embodiments, overcomes the disadvantages noted hereinabove with respect to previous technologies, and achieves advantages heretofore not possible.

The methods, system, apparatuses, and computer-readable media of the present invention enable a person to use contact data in PIM software to automatically populate corresponding field(s) of an application. According to one embodiment of the invention, in a setup mode of operation, a computing device operated by a user receives mapping software and interface software from a remote web server. The user can execute the mapping software using the computing device to generate a graphical user interface which enables the user to map data from one or more fields of the contact data to corresponding field(s) of a web page. The resulting mapping data is stored in a file in the computing device. When the user executes the web application, the user can enter one or more alphanumeric characters into a field of a web page of the web application. The interface software uses the mapping data to reference the PIM software and determine and display those sets of contact data which have a matching character(s) in the mapped field(s) of the web page in which the person entered the alphanumeric character(s). The user of the computing device can select one of the sets of contact data to populate the field(s) of the web application. Thus, the computing device executes the interface software using the mapping data stored in the mapping file, to automatically populate the corresponding field(s) of the web page displayed by the computing device's browser. The user is thus saved the effort of having to enter data for all fields of the web page in order to use the web application.

The invention can be extended beyond the specific example of populating a web page of a web application. It can thus be applied to populate a display screen field of virtually any application with contact data from PIM software, including an application that is not web-based. Moreover, the mapping of contact data can be performed to populate data fields of an application that has no graphical user interface, and thus does not requiring a person to enter the contact data.

These together with other objects and advantages of the invention will be explained in further detail with reference to the accompanying drawings, forming a part of this disclosure, in which like numerals refer to like components throughout the several views and description.

### BRIEF DESCRIPTION OF THE DRAWINGS

FIG. 1 is a block diagram of a system of the invention including a user or client tier with one or more computing devices, and a web tier with a web server, which can be used to map data from fields of contact data from PIM software, to corresponding data fields of a web page, and to transmit the mapped contact data to a web application;

FIG. 2 is a flowchart of processing performed by the web server in the setup and execution modes of operation for use in mapping contact data from PIM software to corresponding fields of a web page;

FIG. 3 is a flowchart of processing performed by a computing device in a setup mode of operation to prepare for mapping contact data to one or more fields of a web page used to interact with an application executed by a web server;

FIG. 4 is a flowchart of processing performed by the computing device in an execution mode of operation in which mapping data is used to map field(s) of the contact data to corresponding field(s) of a web page used to transmit data via a network to a web application executed by a web server; and

FIGS. 5A-5C are views of the display generated by the computing device's demonstrating how a user can search PIM software for desired contact data, and select such data to populate one or more fields of a web page in accordance with the invention.

These together with other objectives and advantages of the invention will hereinafter be described in detail in connection with the following drawings in which like numbered elements refer to like parts throughout the several views.

### DESCRIPTION OF THE PREFERRED EMBODIMENTS

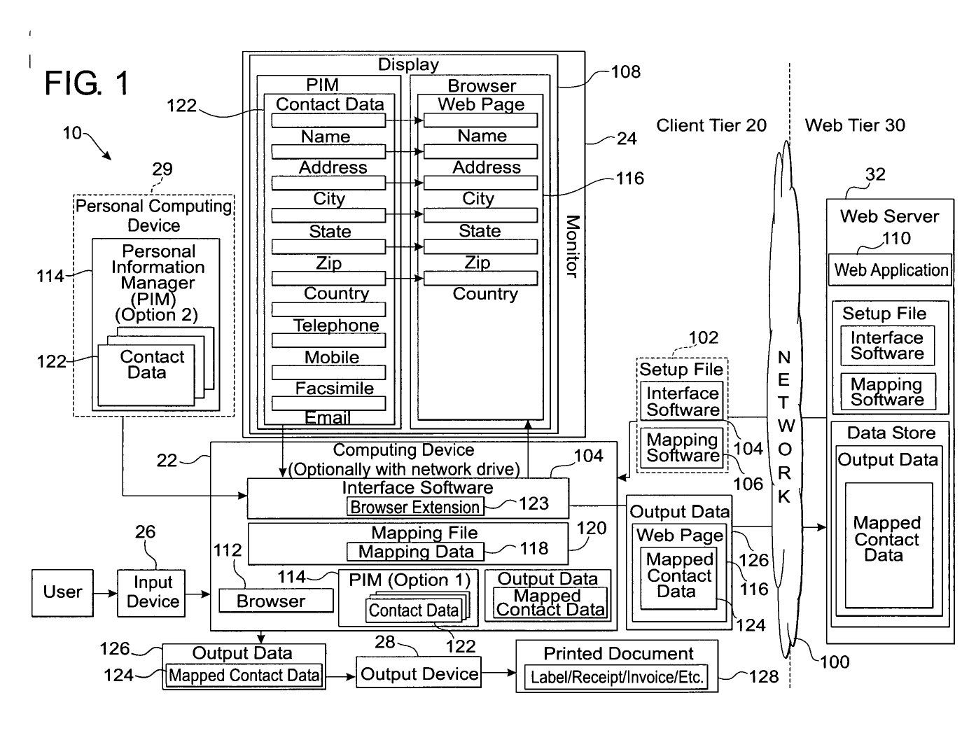

In FIG. 1, a general block diagram of a system 10 in accordance with the invention is shown. The system 10 comprises a client tier 20 and a web tier 30. The client tier 20 comprises a computing device 22, a monitor 24, an input device 26, an output device 28, and can comprise a personal computing device 29. The web tier 30 comprises a web server 32. The web server 32 and computing device 22 can communicate with one another via network 100. The network 100 can be a public communication network such as the Internet, Internet 2, Internet 3, World Wide Web (WWW), WWW2, WWW3 or other similar network. The computing device 22 and web server 32 can communicate via the network 100 through respective Internet Service Providers (ISPs) or other points-of-presence on the network.

In the setup mode of operation, the web server 32 transmits a setup file 102 which includes interface software 104 and mapping software 106. The web server 32 transmits such software over communication network 100 to the computing device 22. The computing device 22 can be a personal computer, laptop computer, or other processor-based device with operating system such as Windows95, Windows98, Windows2000, Windows NT, WindowsXP, Linux, Unix, or other operating system. The computing device 22 receives and stores the set up file 102 in its memory, and, upon activation by the user with the input device 26 such as a mouse or keyboard, executes the mapping software 106. Upon execution of the mapping software 106, the computing device 22 generates a display 108 prompting the user to map the fields of the template used by PIM software 114 to store the contact data 122, to corresponding fields of a web page 116 generated by web application 110 interacting with browser application 112. The contact data 122 and the PIM software 114 can be stored in the computing device 22. Alternatively, or in addition, the contact data 122 and the PIM software 114 can be stored in a personal computing device 29 such as a personal digital assistant (e.g., PalmPilot®, BlackBerry®, iPaq® or other wireless or docked personal communication devices with operating system such as WindowsCE). The mapping of the fields of the contact data of the PIM software 114 to the corresponding fields of the web page 116 of the web application 110, are stored in the computing device 22 as mapping data 118. The mapping data 118 is stored in the computing device 122 in file 120. The computing device 22 is thus prepared to automatically populate the fields of the web page 116 of the application 110. The set up mode of operation is thereby completed.

In the execution mode of operation, the computing device 22 interacts with the web application 110, which transmits the web page 116 to such computing device. The user operates the input device 26 and uses the display 108 to enter alphanumeric characters in one or more fields of the web page 116. Upon entering one or more alphanumeric characters into a field, the computing device 22 executes the interface software 104. Execution of the interface software 104 directs the computing device 22 to refer to the map file 120 and retrieve the mapping data 118 therefrom. Using the mapping data 118, the computing device 22 executes the interface software 104 to search the PIM Software 114 for contact data with one or more alphanumeric character(s) entered by the user in the corresponding field(s), as determined by the mapping data 118. If no such contact data 122 is found, the computing device 22 executes the interface software 104 to generate a message in the display 108 to indicate this fact to the user. Conversely, if one or more sets of contact data 122 are determined to exist in the contact data sets stored by the PIM Software 114, the computing device 22 generates a display to indicate the contact data set(s) to the user with the display 108. The user can then operate the input device 26 with the assistance of the display 108 to select a set of contact data 122 to use to populate the web page 116. Upon such selection, the computing device 22 executes the interface software 104 using the mapping data 118 to map data from the field(s) of the contact data 122, to a corresponding field(s) of the web page 116. The interface software 104 is thus executed by the computing device 22 to automatically populate contact data in the field(s) of the web page 116 using the selected set of contact data 122. More specifically, the interface software 104 can comprise a browser extension 123 that the browser 112 embeds in the web page 116. The browser extension 123 can be an ActiveX® control, a Netscape® plug-in, or other such extension. The browser extension 123 uses the mapping data 118 to map data from the field(s) of the contact data 122 into corresponding field(s) of the web page 116. After population of the field(s) of the web page 116 with mapped contact data 124, the user can operate the input device 26 to transmit the mapped contact data to the web application 110 of the web server 32 via the network 100.

The computing device 22 can output the mapped contact data 124 mapped to the field(s) of the web page, as output data 126. In one context, it is possible that the output data 126 including the mapped contact data 126, can be provided in the web page 116 to the web application 110 of the web server 32 via the network 100. Alternatively, or in addition to outputting the mapped contact data 124 in the web page 116, the computing device 22 can output the mapped contact data 124 as output data 126 to the output device 28. The output device 28 can be a printer or other device used to generate a printed document 128. For example, the printed document 128 could be a label, receipt, invoice, or other such document.

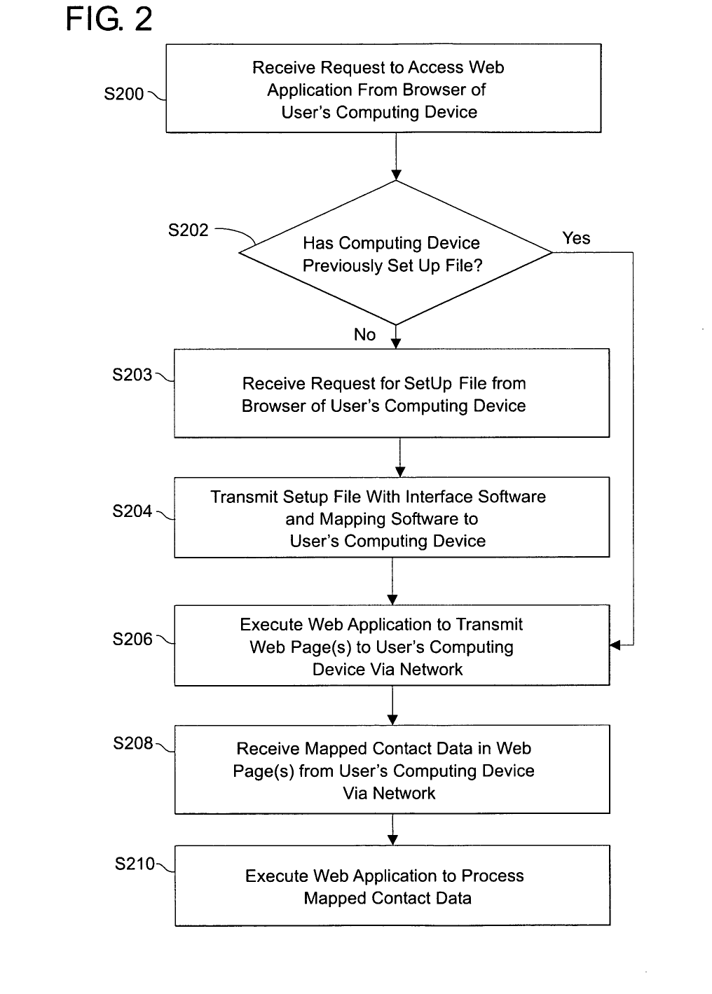

In FIG. 2, a flowchart is shown of processing performed by the web server 32 in the performance of a method of the invention. In step S200, the web server 32 receives a request to access the web application 110 from the browser 112 of the user's computing device 22. This can be initiated by the user's entry of the URL for the web application 110 in the address field of the browser 116. In step S202, a determination is made to establish whether the computing device 22 has previously downloaded the setup file 102 containing the interface software 204 and mapping software 106. The computing device 22 determines this fact by executing a web page which checks to determine whether the interface software 204 and mapping software 106 has previously been installed. If not, the computing device 22 transmits a message to the web server 22 to request the setup file. In step S203, the web server 32 receives the request for the setup file from the user's computing device 22 via the network 100. In step S204, the web server 32 transmits the setup file 102 with interface software 104 and the mapping software 106, to the user's computing device 22 via the network 100. Performance of the step S204 completes involvement of the web server 32 in the setup mode of operation of the system 10. In step S206, the execution mode of operation performed by the web server 32 begins. In step S206, if the determination in step S202 is affirmative or after completion of step S204, the web server 32 executes the web application 110 to transmit a web page 116 to the user's computing device 22 via the network 100. In step S208, the web server 32 receives the mapped contact data 124 in the web page 116 from the user's computing device 22 via the network 100. In step S210, the web server 32 executes the web application 110 to process the mapped contact data 124.

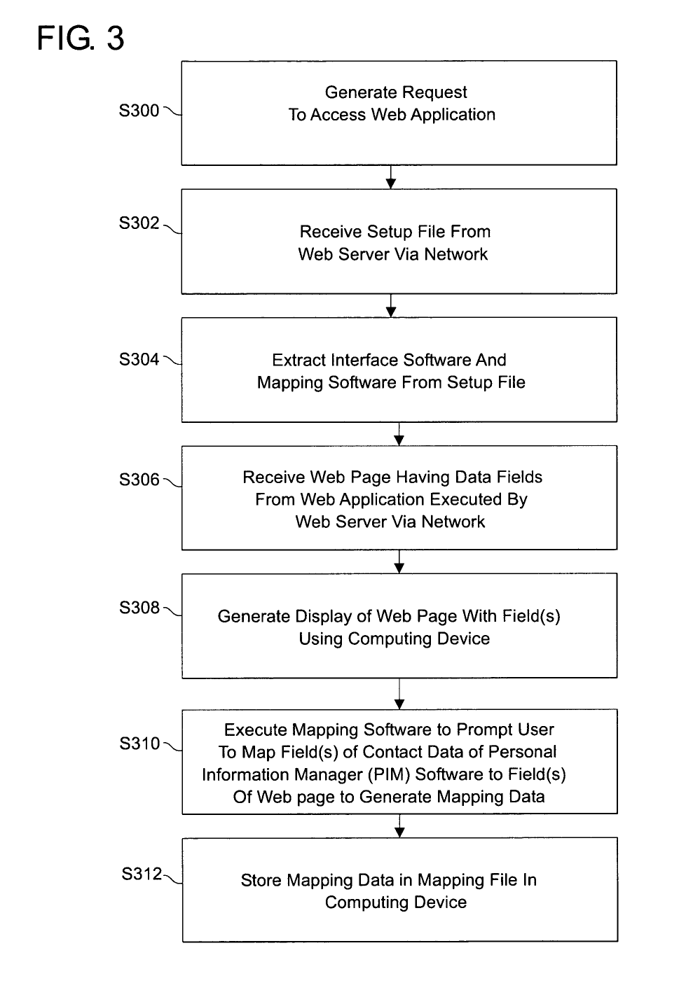

FIG. 3 is a flow chart of processing performed by the computing device 22 in the set up mode of operation. In Step S300, the computing device 22 executes the browser application 112 to generate a request to access a web page application 110 based on a URL entered by the user with input device 126. In step S302, in response to the request to the web application 110, the computing device 22 receives the set up file 102 including the interface software 104 and the mapping software 106. In step S304, the computer device 22 extracts the interface software 104 and the mapping software 106 from the setup file 102. In step S306, the computer device 22 receives the web page 116 having one or more fields for entry of data from the web application 110 executed by the web server 32, via the network 100. In step S308, the computer device 22 generates the display 108 by using the web page 116. In step S310, the computer device 22 executes the mapping software 106 to prompt the user to map the field(s) of the contact data 122 of the PIM software 114, to corresponding field(s) of the web page 116. The computer device 22 thus generates the mapping data 228 that associates data in the field(s) of the contact data 122, to populate such data in the field(s) of the web page 116. In step S312, the computing device 22 stores the mapping data 118 of the mapping file 120 in the memory of the computing device 22.

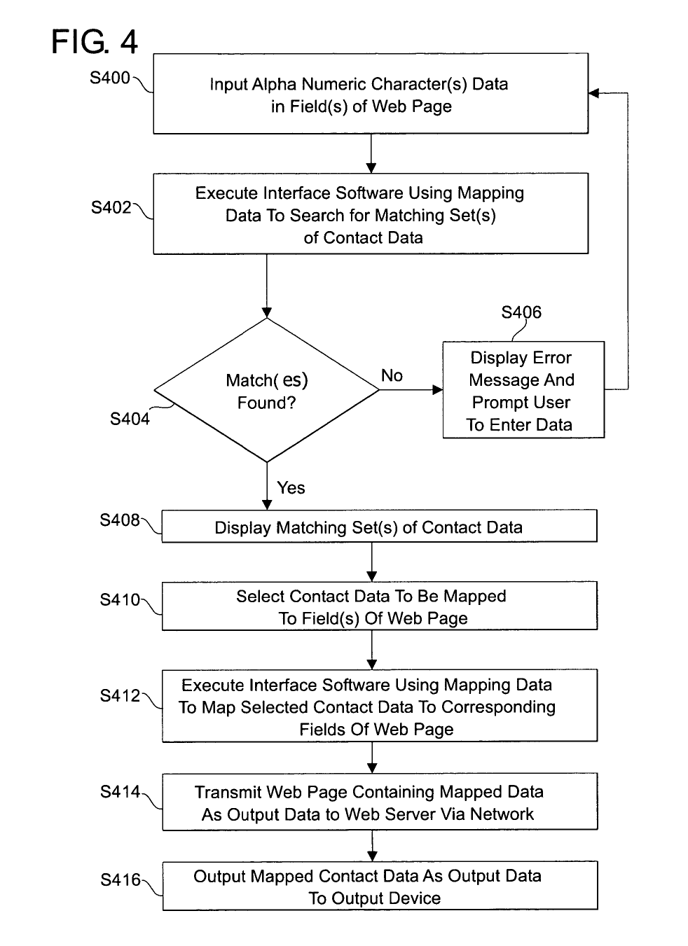

In FIG. 4, a method performed by the computing device 22 in the execution mode of operation of the computing device 22, is shown. In step S400, the user inputs alphanumeric character data in field(s) of the web page 116 using the input device 26 and the display 108 generated by the computing device 22. In step S402, in response to the users input of the alphanumeric character data, the computing device 22 executes the interface software 104 using the mapping data 118, to search for sets of contact data 122 of PIM software 114, for matching alphanumeric character data in corresponding field(s) determined by the mapping data. In step S404, if the computing device 22 determines that matching alphanumeric data entered in the web page 116 is not present in corresponding field(s) of the contact data 122, in step S406, the computing device 22 displays an error message and prompts the user to reenter alphanumeric character data. Conversely, if the computing device 22 determines that alphanumeric character data in a field(s) of one or more sets of contact data 122 matches that entered in a corresponding field(s) of the web page by the user, in step S408, the computing device 22 generates the display 108 on the monitor 24 to present the matching set(s) of contact data 122. In step S410, the user operates input device 26 to select a set of contact data 122 to be mapped to field(s) of the web page 116. In step S412, the computing device 22 executes the interface software 104 using the mapping data 118 for the web page 116, to map data in the field(s) of the selected contact data 122 to a corresponding field(s) of the web page 116. In step S414, the user operates the input device 26 to cause the computing device 22 to transmit the web page 116 containing the mapped data contact data 124 to the web server 32 via the network 100. The web server 32 can execute the web application 110 to process the mapped contact data 124 in the returned web page 116. For example, if the web application 110 is an application for shipping a letter or package to an addressee, the web application 110 may be such as to generate a “soft” shipping label which is transmitted back to the computing device 22 via the network 100. In step S416, the computing device 22 outputs the mapped contact data 124 as output data 126 to the output device 28. The output device 28 can be a printer, in which case the output device produces a printed document 128. For example, if the web application 110 is used to shipped a letter or package, the printed document 128 could be a shipping label that is applied to a letter or package for transport to an intended recipient at an address indicated by the mapped contact data 124. However, the web application 110 is not restricted to a shipping application, but may be of another type such as an application used to purchase a product or service. Thus, the printed document 128 can be a receipt for purchase of a product, an invoice to be sent to a party to be billed, or another type of document. Moreover, the computing device 22 can store the mapped contact data 124 for later use. As another possibility, the computing device 22 can transmit the mapped contact data 124 to a remote storage device for later use or to serve as a transaction record, for example. As a further possibility, the computing device 22 can use the mapped contact data 124 in an entirely different application resident on the computing device 22 or elsewhere in a networked environment, such as in another server or computing device. It will thus be appreciated that the scope of use of the mapped contact data 124 is virtually unrestricted.

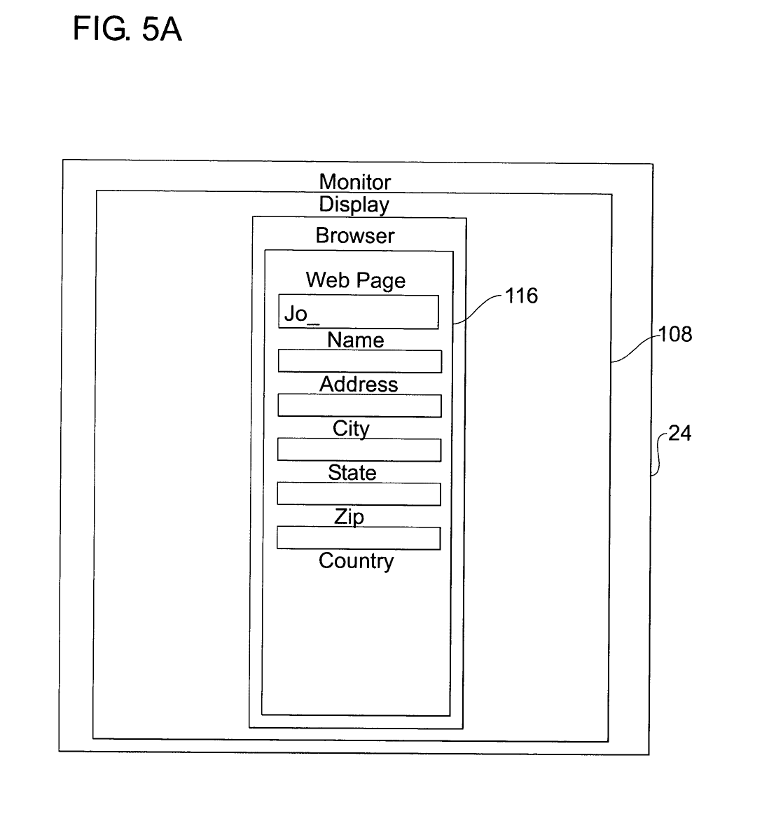

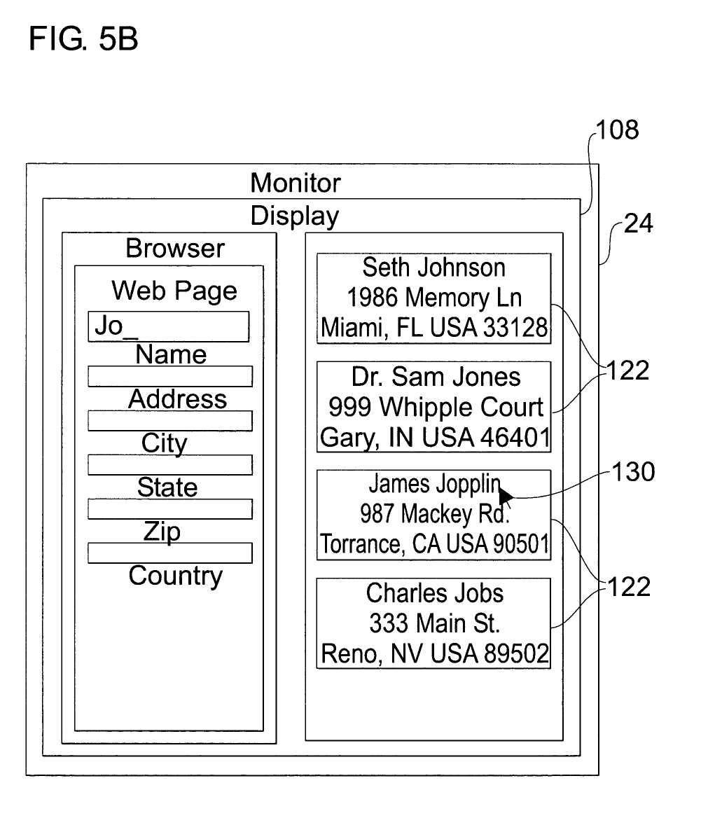

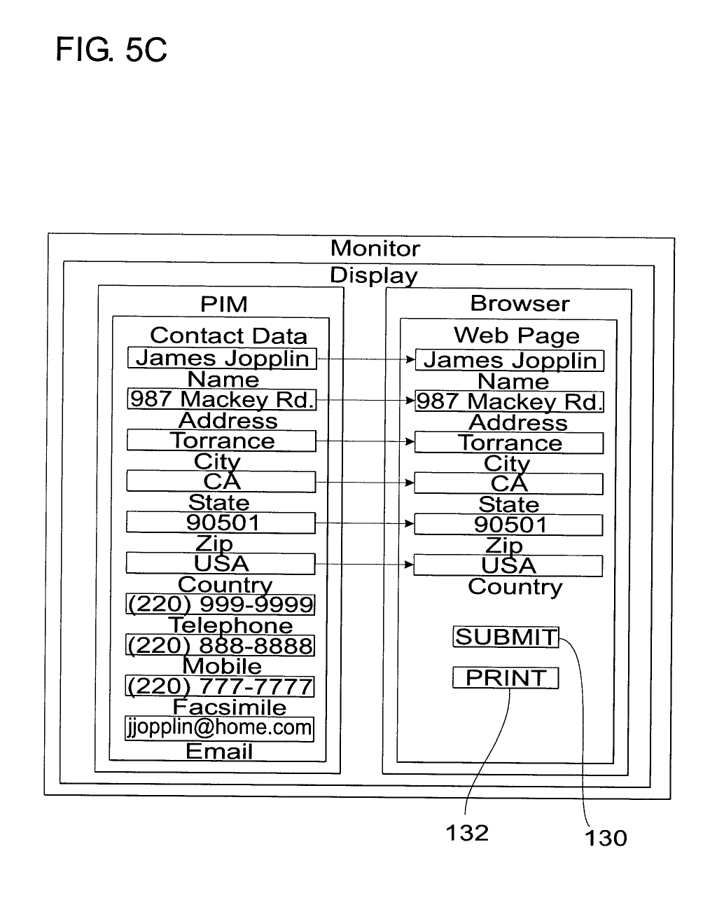

In FIG. 5A, a display 108 generated by the monitor 24 under control of the computing device 22 includes a web page 116 having fields prompting the user to enter a name, address, city, state, zip code, and country. The user enters the letter “Jo” into the main field of the web page 116 and activates the enter key of input device 26. The computing device 22 executes the interface software 104 using the mapping data 118 to retrieve contact data 122 which has the same 2 letters “Jo” in the last name field of the contact data 122. The computing device 22 retrieves the matching sets of contact data 122 and displays them on the monitor 24, as shown in FIG. 5B. In this example, the user operates the input device 26 to move the cursor 130 over the contact data 122 corresponding to “James Joplin” and activates the input device. In response activation of the input device 26, the computing device 22 executes the interface software 104 using the mapping data 118, to map the data from the fields of the contact data 122 into corresponding fields of the web page 116, as shown in FIG. 5C. The fields of the web page 116 are thus automatically populated with the selected contact data. The user can operate the input device 26 to activate soft submit button 132 to transmit the mapped contact data in the web page 116 to the web server 32 via the network 100. The user can also operate the input device 26 to activate the soft print button 132 to send the mapped contact data 124 to the out put device 28 to generate printed document 128.

Although the invention has been described herein with reference to specific embodiments and examples, it is not necessarily intended to limit the scope of the invention to the specific embodiments and examples disclosed. Thus, in addition to claiming the subject matter literally as defined in the appended claims, all modifications, alterations, and equivalents to which the applicant is entitled by law, are herein expressly reserved by the following claims.

What is claimed is:

1. A method comprising:
mapping contact data from personal information manager (PIM) software to automatically populate an application.

2. A method as claimed in claim 1 wherein the application is a web application, and the mapping of the contact data is performed to map one or more fields of contact data to one or more corresponding fields of a web page of the web application.

3. A method as claimed in claim 2 wherein the mapping is performed using mapping data that defines the mapping of at least one field of the contact data from the PIM software to at least one corresponding field of the web page.

4. A method as claimed in claim 2 wherein the mapping data is mapped to map the field of contact data to the corresponding field of the web application via a browser extension embedded in the web page of the application.

5. A method as claimed in claim 4 wherein the extension is an ActiveX® control.

6. A method as claimed in claim 4 wherein the extension is a Netscape® plug-in.

7. A method as claimed in claim 2 wherein a user of the web application uses a computing device to enter one or more alphanumeric characters into a field, the method further comprising:
displaying one or more sets of contact data for the user to select for mapping to the fields of the web page.

8. A method as claimed in claim 2 further comprising:
transmitting the web page populated with contact data via a public communications network to a server executing the web application.

9. A method as claimed in claim 1 further comprising:
outputting the mapped contact data generated by automatically populating the contact data to the application, to an output device.

10. A method as claimed in claim 9 wherein the output device generates a printed document based on the mapped contact data.

11. A method as claimed in claim 1 wherein the public communications network is the Internet.

12. A method as claimed in claim 1 wherein the contact data comprises a person's name.

13. A method as claimed in claim 1 wherein the contact data comprises a company name.

14. A method as claimed in claim 1 wherein the contact data comprises an address.

15 A method as claimed in claim 1 wherein the contact data comprises a telephone number.

16. A method as claimed in claim 1 wherein the contact data comprises a mobile number.

17. A method as claimed in claim 1 wherein the contact data comprises a facsimile number.

18. A method as claimed in claim 1 wherein the contact data comprises an email address.

19. A method comprising:
receiving mapping software at a computing device from a public communications network, the mapping software for generating mapping data that maps at least one field of contact data from a personal information manager (PIM) software to at least one corresponding field of a web application.

20. A method as claimed in claim 19 wherein the application is a web application, and the mapping software can be operated by a user to generate the mapping data to map at least one field of the contact data to at least one corresponding field of the web page of the web application.

21. A method as claimed in claim 19 further comprising:
receiving interface software for automatically populating the web page of the web application with contact data based on the mapping data generated by the mapping software.

22. A method as claimed in claim 21 wherein the interface software enables a user of the computing device to enter one or more alphanumeric characters, and the interface software generates a display of one or more sets of contact data corresponding to the characters entered by the user, the user selecting from among the displayed sets of contact data to populate the web page of the web application.

23. A method as claimed in claim 21 wherein the interface software comprises a browser extension embedded in the web page of the web application by a web browser of the computing device.

24. A method as claimed in claim 23 wherein the browser extension is an ActiveX® control.

25. A method as claimed in claim 23 wherein the browser extension is a Netscape® plug-in.

26. A method comprising:
receiving interface software at a computing device from a public communications network, the interface software for automatically populating the web page of the web application with contact data based on the mapping data generated by the mapping software.

27. A method as claimed in claim 26 wherein the interface software enables a user of the computer to enter one or more alphanumeric characters, and the interface software generates a display of one or more sets of contact data corresponding to the characters entered by the user, the user selecting from among the displayed sets of contact data to populate the web page of the web application.

28. A method as claimed in claim 26 wherein the interface software comprises a browser extension embedded in the web page of the web application by a web browser of the computing device.

29. A method as claimed in claim 28 wherein the browser extension comprises an ActiveX® control.

30. A method as claimed in claim 28 wherein the browser extension comprises a Netscape® plug-in.

31. A method comprising:
transmitting mapping software for generating mapping data that maps contact data from a personal information manager (PIM) software to an application.

32. A method as claimed in claim 31 wherein the transmitting is performed at a web server to transmit the mapping software over a public communications network to a computing device.

33. A method as claimed in claim 31 wherein the application is a web application.

34. A method as claimed in claim 33 wherein the mapping software maps one or more fields of the contact data to one or more corresponding fields of a web page of the web application to generate the mapping data.

35. A method as claimed in claim 34 wherein the mapping software can be operated by a user to generate the mapping data by indicating the mapping of at least one field of the contact data to at least one corresponding field of the web page of the web application.

36. A method as claimed in claim 31 further comprising:
transmitting interface software for automatically populating the application with contact data based on the mapping data generated by the mapping software.

37. A method as claimed in claim 36 wherein the interface software enables a user to enter one or more alphanumeric characters into a computing device running the interface software, and the interface software generates a display of one or more sets of contact data corresponding to the one or more characters entered by the user, the user selecting from among the displayed sets of contact data to populate the application.

38. A method as claimed in claim 36 wherein the interface software comprises a browser extension embedded in a web page of the web application by a web browser of the computing device.

39. A method as claimed in claim 38 wherein the browser extension comprises an ActiveX control.

40. A method as claimed in claim 38 wherein the browser extension comprises a Netscape® plug-in.

41. A method as claimed in claim 36 wherein the mapping software and interface software are received by a computing device executing the mapping software and interface software in a set-up file from a remote web server via a public communications network.

42. A method as claimed in claim 41 wherein the public communications network is the Internet.

43. A method as claimed in claim 31 wherein the contact data comprises a person's name.

44. A method as claimed in claim 31 wherein the contact data comprises a company name.

45. A method as claimed in claim 31 wherein the contact data comprises an address.

46. A method as claimed in claim 31 wherein the contact data comprises a telephone number.

47. A method as claimed in claim 31 wherein the contact data comprises a mobile number.

48. A method as claimed in claim 31 wherein the contact data comprises a facsimile number.

49. A method as claimed in claim 31 wherein the contact data comprises an email address.

50. A method comprising:
transmitting interface software for automatically populating an application with contact data from personal information manager (PIM) software based on mapping data.

51. A method as claimed in claim 50 wherein the application is a web application.

52. A method as claimed in claim 50 wherein the interface software enables a user of the computer to enter one or more alphanumeric characters, and the interface software generates a display of one or more sets of contact data corresponding to the one or more characters entered by the user, the user selecting from among the displayed sets of contact data to populate a web page of the web application.

53. A method as claimed in claim 50 wherein the interface software comprises a browser extension embedded in the web page of the web application by a web browser of the computing device.

54. A method as claimed in claim 53 wherein the browser extension comprises an ActiveX® control.

55. A method as claimed in claim 53 wherein browser extension comprises a Netscape® plug-in.

56. A method as claimed in claim 50 wherein the interface software is transmitted by a server over a public communications network to a computing device for execution thereon.

57. A method as claimed in claim 56 wherein the public communications network is the Internet.

58. A method as claimed in claim 50 wherein the contact data comprises a person's name.

59. A method as claimed in claim 50 wherein the contact data comprises a company name.

60. A method as claimed in claim 50 wherein the contact data comprises an address.

61 A method as claimed in claim 50 wherein the contact data comprises a telephone number.

62. A method as claimed in claim 50 wherein the contact data comprises a mobile number.

63. A method as claimed in claim 50 wherein the contact data comprises a facsimile number.

64. A method as claimed in claim 50 wherein the contact data comprises an email address.

65. An apparatus comprising:
a computing device executing interface software to map contact data from personal information manager (PIM) software to automatically populate an application.

66. An apparatus as claimed in claim 65 wherein the application is a web application, and the mapping of the contact data is performed by the computing device to map one or more fields of contact data to one or more corresponding fields of a web page of the web application.

67. An apparatus as claimed in claim 65 wherein the mapping is performed by the computing device using mapping data that defines the mapping of at least one field of the contact data from the PIM software to at least one corresponding field of the web page.

68. An apparatus as claimed in claim 65 wherein the mapping data is defined through execution of mapping software by the computing device so that the user can specify the mapping of fields of the contact data to corresponding fields of the web page.

69. An apparatus as claimed in claim 65 wherein the mapping data is used by the computing device to map the field of the contact data to the corresponding field of the web page of the web application via a browser extension embedded in the web page of the application.

70. An apparatus as claimed in claim 69 wherein the browser extension comprises an ActiveX® control.

71. An apparatus as claimed in claim 69 wherein the browser extension comprises a Netscape® plug-in.

72. A method as claimed in claim 65 wherein a user of the web application uses a computing device to enter one or more alphanumeric characters into a field of a web page of the web application, the method further comprising:
displaying one or more sets of contact data for the user to select for mapping to the one or more fields of the web page.

73. A method as claimed in claim 65 further comprising:
transmitting the web page populated with contact data via a public communications network to a server executing the web application.

74. A method as claimed in claim 65 further comprising:
outputting the mapped contact data generated by automatically populating the contact data to the application, to an output device.

75. A method as claimed in claim 65 wherein the output device generates a printed document based on the mapped contact data.

76. A method as claimed in claim 65 wherein the public communications network is the Internet.

77. A method as claimed in claim 65 wherein the contact data comprises at least one of a person's name, a company name, an address, a telephone number, a mobile number, a facsimile number, and an email address.

78. A system using a public communications network, the system comprising:
a web server having a web application with at least one web page, and a set-up file with mapping software and interface software; and
a computing device connected to communicate with the web server via the public communications network, and having personal information manager (PIM) software storing contact data,
the web server transmitting the set-up file to the computing device via the public communications network,
the computing device receiving the set-up file from the web server and executing the mapping software to map at least one field of contact data from the PIM software to at least one field of a web page of the web application to generate mapping data, and executing the interface software to map at least one field of contact data to at least one field of the web page of the web application based on the mapping data, to automatically populate the field of the web page with corresponding data.

79. A system as claimed in claim 78 wherein the computing device transmits the web page with populated data to the web server via the public communications network for processing by the web application executed by the web server.

80. A system as claimed in claim 78 further comprising:
an output device connected to the computing device, the output device generating a printed document having mapped contact data automatically populated by the application.

81. A method as claimed in claim 78 wherein the output device generates a printed document based on the mapped contact data.

82. A method as claimed in claim 78 wherein the public communications network is the Internet.

83. A method as claimed in claim 82 wherein the contact data comprises at least one of a person's name, a company name, an address, a telephone number, a mobile number, a facsimile number, and an email address.

84. A computer-readable medium having a software executable by a computer to map contact data from personal information manager (PIM) software to automatically populate an application with contact data.

85. A computer-readable medium as claimed in claim 84 wherein the application is a web application, and the mapping of the contact data is performed to map one or more fields of contact data to one or more corresponding fields of a web page of the web application.

86. A computer-readable medium as claimed in claim 84 wherein the mapping is performed using mapping data that defines the mapping of at least one field of the contact data from the PIM software to at least one corresponding field of the web page.

87. A computer-readable medium as claimed in claim 84 wherein the mapping data is mapped to map contact data to the corresponding fields of the web application via a browser extension embedded in the web page of the application.

88. A computer-readable medium as claimed in claim 87 wherein the browser extension comprises a ActiveX® control.

89. A computer-readable medium as claimed in claim 87 wherein the browser extension comprises a Netscape® plug-in.

90. A computer-readable medium as claimed in claim 84 wherein a user of the web application uses a computing device to enter one or more alphanumeric characters into a field of a web page of the web application, the computer program executable by the computing device to display one or more sets of contact data for the user to select for mapping to the fields of the web page.

91. A computer-readable medium as claimed in claim 84 wherein the computer program is executable by the computer to transmit the web page populated with contact data via a public communications network to a server executing the web application.

92. A computer-readable medium as claimed in claim 84 wherein the computer program is executable by the computer to output the mapped contact data generated by automatically populating the contact data to the application, to an output device.

93. A computer-readable medium as claimed in claim 84 wherein the output device generates a printed document based on the mapped contact data.

94. A computer-readable medium as claimed in claim 84 wherein the public communications network is the Internet.

95. A computer-readable medium as claimed in claim 84 wherein the contact data comprises a person's name.

96. A computer-readable medium as claimed in claim 84 wherein the contact data comprises a company name.

97. A computer-readable medium as claimed in claim 84 wherein the contact data comprises an address.

98. A computer-readable medium as claimed in claim 84 wherein the contact data comprises a telephone number.

99. A computer-readable medium as claimed in claim 84 wherein the contact data comprises a mobile number.

100. A computer-readable medium as claimed in claim 84 wherein the contact data comprises a facsimile number.

101. A computer-readable medium as claimed in claim 84 wherein the contact data comprises an email address.

102. A computer-readable medium having mapping software executable by a computer to generate mapping data that maps contact data from personal information manager (PIM) software to an application.

103. A computer-readable medium as claimed in claim 102 wherein the medium receives the mapping software from a web server over a public communications network to a computing device.

104. A computer-readable medium as claimed in claim 102 wherein the application is a web application.

105. A computer-readable medium as claimed in claim 102 wherein the mapping software maps one or more fields of the contact data to one or more corresponding fields of a web page of the web application to generate the mapping data.

106. A computer-readable medium as claimed in claim 105 wherein the mapping software can be operated by a user to generate the mapping data by indicating the mapping of at least one field of the contact data to at least one corresponding field of the web page of the web application.

107. A computer-readable medium as claimed in claim 106 wherein the transmitting interface software for automatically populating the application with contact data based on the mapping data generated by the mapping software.

108. A computer-readable medium as claimed in claim 107 wherein the interface software enables a user to enter one or more alphanumeric characters into a computing device running the interface software, and the interface software generates a display of one or more sets of contact data corresponding to the one or more characters entered by the user, the user selecting from among the displayed sets of contact data to populate the application.

109. A computer-readable medium as claimed in claim 108 wherein the interface software comprises a browser extension embedded in a web page of the web application by a web browser of the computing device.

110. A computer-readable medium as claimed in claim 109 wherein the browser extension comprises an ActiveX® control.

111. A computer-readable medium as claimed in claim 109 wherein the browser extension comprises a Netscape® plug-in.

112. A computer-readable medium as claimed in claim 108 wherein the mapping software and interface software are received by a computing device executing the mapping software and interface software in a set-up file from a remote web server via a public communications network.

113. A computer-readable medium as claimed in claim 112 wherein the public communications network is the Internet.

114. A computer-readable medium as claimed in claim 102 wherein the contact data comprises a person's name.

115. A computer-readable medium as claimed in claim 102 wherein the contact data comprises a company name.

116. A computer-readable medium as claimed in claim 102 wherein the contact data comprises an address.

117. A computer-readable medium as claimed in claim 102 wherein the contact data comprises a telephone number.

118. A computer-readable medium as claimed in claim 102 wherein the contact data comprises a mobile number.

119. A computer-readable medium as claimed in claim 102 wherein the contact data comprises a facsimile number.

120. A computer-readable medium as claimed in claim 102 wherein the contact data comprises an email address.
